(19) United States
(12) Patent Application Publication
(10) Pub. No.: US 2024/0025418 A1
(43) Pub. Date: Jan. 25, 2024

(54) PROFILE MODELING

(71) Applicant: Honda Motor Co., Ltd., Tokyo (JP)

(72) Inventors: Xishun LIAO, Riverside, CA (US); Shashank MEHROTRA, Campbell, CA (US); Chun-Ming Samson HO, San Leandro, CA (US); Teruhisa MISU, San Jose, CA (US)

(21) Appl. No.: 17/869,426

(22) Filed: Jul. 20, 2022

(51) Int. Cl. B60W 40/09; G06N 3/04

(52) U.S. Cl. CPC B60W 40/09; G06N 3/0436; B60W 2540/043; B60W 2556/10

(57) ABSTRACT

According to one aspect, profile modeling may be achieved by receiving a first set of data and performing feature selection on the first set of data, receiving a second set of data and performing classification on the second set of data using fuzzy logic inference, receiving a third set of data and performing clustering on the third set of data using hierarchical cluster analysis, and generating a prediction model based on the first set of data, the second set of data, and the third set of data. The prediction model may generate a prediction for profile modeling by receiving a first input of the same data type as the first set of data, a second input of the same data type as the second set of data and outputting the prediction for profile modeling having the same data type as the third set of data.

### BACKGROUND

Recent developments in automated driving technologies may result in road interactions between automated vehicles (AVs) and human-driven vehicles. With these advancements, the role of the driver may change. These interactions between AVs and human-driven vehicles may present unique challenges to driver state assessment.

### BRIEF DESCRIPTION

According to one aspect, a system for profile modeling may include a feature selector, a fuzzy logic inference system, a hierarchical cluster analyzer, and a model generator. The feature selector may receive a first set of data and perform feature selection on the first set of data. The fuzzy logic inference system may receive a second set of data and perform classification on the second set of data. The hierarchical cluster analyzer may receive a third set of data and perform clustering on the third set of data. The model generator may generate a prediction model based on the first set of data, the second set of data, and the third set of data. The prediction model may generate a prediction for profile modeling by receiving a first input of the same data type as the first set of data, a second input of the same data type as the second set of data and output the prediction for profile modeling having the same data type as the third set of data.

The data type of the first set of data may be mood state information associated with an individual, and may include anger, confusion, depression, fatigue, tension, or vigor. The data type of the second set of data may be driving style information associated with an individual, and may include aggressive, anxious, keen, or sedate. The data type of the third set of data may be personality trait information associated with an individual, and may include neuroticism, extroversion, openness, agreeableness, or conscientiousness.

The fuzzy logic inference system may perform classification on the second set of data by evaluating an individual's reaction to a defined event presented during simulation or a data collection phase. The defined event may be one of a normal driving scenario without surrounding vehicles, a vehicle following scenario, a stop sign scenario, or a lane change scenario within the simulation or the data collection phase. Evaluating the individual's reaction to the defined event may include monitoring a speed near a speed limit sign, a minimum speed at a stop sign, a maximum acceleration after the stop sign, or a maximum deceleration near the stop sign within the simulation or the data collection phase. The fuzzy logic inference system may perform classification on the second set of data based on a Non-dominated Sorting Genetic Algorithm II (NSGA-II) which optimizes weights for the classification. The model generator may generate the prediction model based on random decision forest. The prediction model may generate a second prediction for profile modeling by receiving the first input of the same data type as the first set of data, the second input of the same data type as the third set of data and outputting the prediction for profile modeling having the same data type as the second set of data.

According to one aspect, a computer-implemented method for profile modeling may include receiving a first set of data and performing feature selection on the first set of data, receiving a second set of data and performing classification on the second set of data using fuzzy logic inference, receiving a third set of data and perform clustering on the third set of data using hierarchical cluster analysis, and generating a prediction model based on the first set of data, the second set of data, and the third set of data. The prediction model may generate a prediction for profile modeling by receiving a first input of the same data type as the first set of data, a second input of the same data type as the second set of data and outputting the prediction for profile modeling having the same data type as the third set of data.

The data type of the first set of data may be mood state information associated with an individual, and may include anger, confusion, depression, fatigue, tension, or vigor. The data type of the second set of data may be driving style information associated with an individual, and may include aggressive, anxious, keen, or sedate. The data type of the third set of data may be personality trait information associated with an individual, and may include neuroticism, extroversion, openness, agreeableness, or conscientiousness.

According to one aspect, a system for profile modeling may include a feature selector, a fuzzy logic inference system, a hierarchical cluster analyzer, and a model generator. The feature selector may receive a first set of data and perform feature selection on the first set of data. The fuzzy logic inference system may receive a second set of data and perform classification on the second set of data. The hierarchical cluster analyzer may receive a third set of data and perform clustering on the third set of data. The model generator may generate a prediction model based on the first set of data, the second set of data, and the third set of data. The prediction model may generate a prediction for profile modeling by receiving a first input of the same data type as the first set of data, a second input of the same data type as the third set of data, and outputting the prediction for profile modeling having the same data type as the second set of data.

The data type of the first set of data may be mood state information associated with an individual, and may include anger, confusion, depression, fatigue, tension, or vigor. The data type of the second set of data may be driving style information associated with an individual, and may include aggressive, anxious, keen, or sedate. The data type of the third set of data may be personality trait information associated with an individual, and may include neuroticism, extroversion, openness, agreeableness, or conscientiousness. The fuzzy logic inference system may perform classification on the second set of data by evaluating an individual's reaction to a defined event presented during simulation or a data collection phase. The defined event may be one of a normal driving scenario without surrounding vehicles, a vehicle following scenario, a stop sign scenario, or a lane change scenario within the simulation or the data collection phase.

### BRIEF DESCRIPTION OF THE DRAWINGS

FIG. 1 is an exemplary component diagram of a system for profile modeling, according to one aspect.

FIG. 2 is an exemplary flow diagram of a method for profile modeling, according to one aspect.

FIG. 3 is an exemplary architecture for the system for profile modeling of FIG. 1, according to one aspect.

FIG. 4 is an illustration of an example computer-readable medium or computer-readable device including processor-executable instructions configured to embody one or more of the provisions set forth herein, according to one aspect.

FIG. 5 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

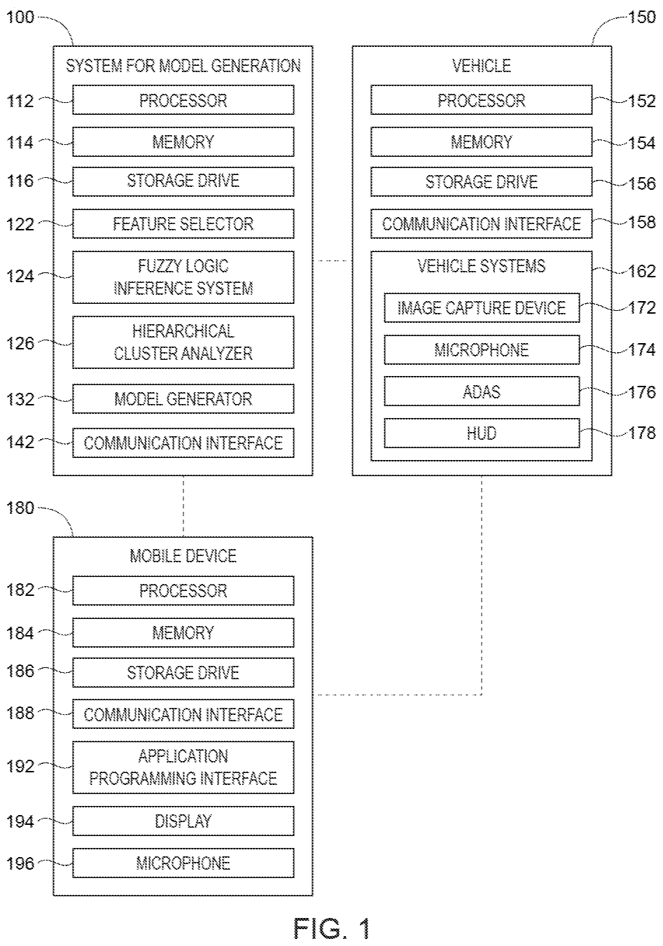

FIG. 1 is an exemplary component diagram of a system 100 for profile modeling, according to one aspect. The system 100 for profile modeling may include a processor 112, a memory 114, a storage drive 116, a feature selector 122, a fuzzy logic inference system 124, a hierarchical cluster analyzer 126, a model generator 132, and a communication interface 142. One or more of the feature selector 122, the fuzzy logic inference system 124, the hierarchical cluster analyzer 126, the model generator 132 may be implemented via the processor 112, the memory 114, and/or the storage drive 116 to perform one or more acts, actions, steps, and/or algorithms described herein. The communication interface 142 of the system 100 for profile modeling may enable models, such as prediction models generated by the system 100 for profile modeling to be transmitted to operably connected systems via corresponding communication interfaces (e.g., 142, 158, 188) to respective or corresponding storage drives (e.g., 116, 156, 186), such as a vehicle 150 or a mobile device 180, for example. A communication interface may include a transmitter, a receiver, a port, etc.

The vehicle 150 may include a processor 152, a memory 154, a storage drive 156, a communication interface 158, and one or more vehicle systems 162. Examples of vehicle systems 162 may include an image capture device 172, a microphone 174, an advanced driver-assistance system (ADAS) 176, a heads-up-display (HUD) 178, among other vehicle systems 162.

The mobile device 180 may include a processor 182, a memory 184, a storage drive 186, a communication interface 188, an application programming interface (API) 192, a display 194, a microphone 196, image capture device, etc. The mobile device 180 may be a cellular device, a smartwatch, or a fitness tracker, for example.

According to one aspect, the system 100 for profile modeling may provide driver profiles in the development of systems (e.g., vehicle systems 162) that may adapt to the user and to which the user may trust. Understanding the driving profile may be challenging as the driver profile may include several factors, such as a driving style, one or more mood states, and one or more personality traits. According to one aspect, the driver profile may include demographic, physiological, or behavioral characteristics.

According to one aspect, different sets of data may be received or collected during a simulation phase or a data collection phase, such as a first set of data, a second set of data, or a third set of data. Data cleaning may be performed to filter out unrealistic sessions (e.g., driving on the sidewalk within the city driving simulation scenario) from these sets of data (e.g., the first set of data, the second set of data, the third set of data, etc.).

A data type of the first set of data may be mood state information associated with an individual, and may include anger, confusion, depression, fatigue, tension, or vigor. Mood states may be defined as an emotional state that affects the way people or individuals respond to stimuli. This mood state information may be in the form of a set of mood state T-scores from a Mean Profile of Mood States (POMS) assessment and may be collected from surveys of one or more individuals who participate in the driving simulation or data collection phase and this information or group of features may be utilized to create a dataset for the first set of data.

According to one aspect, the POMS assessment may be the Profile of Mood States 2nd Edition-Adult Short (POMS 2-A Short) survey. The responses of this POMs assessment may produce eight factors, including scores for six mood clusters: Anger-Hostility (Anger), Confusion-Bewilderment (Confusion), Depression-Dejection (Depression), Fatigue-Inertia (Fatigue), Tension-Anxiety (Tension), and Vigor-Activity (Vigor). Additionally, two general scores may be generated: a Total Mood Disturbance (TMD) score and a Friendliness score.

A data type of the second set of data may be driving style information associated with an individual, and may include aggressive, anxious, keen, or sedate. According to another aspect, the driving style may be labeled from mild to aggressive, driving performance may be labeled from good to bad, and dynamic demand analyzed (e.g., sport, moderate, economical, etc.). According to one aspect, the second set of data may be obtained through the driving simulation. In other words, features, such as vehicle operation states or driving trajectories (e.g., vehicle coordinates, axes, yaw, pitch, rotation, speed, acceleration, angular speed, throttle, brake, steering angle, distance from other objects or vehicles), associated with the one or more individuals may be collected during the driving simulation or data collection phase and this information or group of features may be utilized to create the dataset for the second set of data.

Further, during the driving simulation phase, one or more defined events may be presented to individuals, and their responses recorded. The defined event may be one of a normal driving scenario without surrounding vehicles, a vehicle following or preceding scenario (e.g., another vehicle is in front of the vehicle 150 that the individual is driving during the simulation), a stop sign scenario, a speed limit sign scenario, a distraction scenario or a sudden lane change scenario by another vehicle within the simulation or the data collection phase. Evaluating the individual's reaction to the defined event may include monitoring baseline behavior, monitoring a speed near a speed limit sign, a minimum speed at a stop sign, a maximum acceleration after the stop sign, and a maximum deceleration near the stop sign within the simulation or the data collection phase, lane keeping behavior, lane change rate, or other vehicle dynamics, such as driving trajectories, etc. The simulation may be set in an urban city simulation environment and/or a highway simulation environment. Additionally, a mood check may be performed before or after the simulation.

A data type of the third set of data may be personality trait information associated with an individual, and may include neuroticism, extroversion, openness, agreeableness, or conscientiousness. Personality traits may include individual differences in characteristic patterns of thinking, feeling, and behaving. The third set of data may be in the form of a big five (e.g., of the five factor personality model) personality trait T-scores from a personality assessment and may be collected from surveys of the one or more individuals who participated in the driving simulation or data collection phase and this information or group of features may be utilized to create the dataset for the third set of data. According to one aspect, a NEO Personality Inventory-3 (NEO-PI-3) questionnaire may be utilized as one of the surveys for determining the personality type.

The raw scores of the five factors and associated sub-scores may be calculated based on the survey responses, and for each trait (e.g., neuroticism, extroversion, openness, agreeableness, or conscientiousness), standardized T scores may be utilized. The T score may represent the standardized values for each personality trait. For example, a score of 50 may represent the mean and a difference of 10 from the mean may be a difference of one standard deviation.

According to one aspect, the feature selector 122 may receive the first set of data and perform feature selection on the first set of data. According to one aspect, Principal Component Analysis (PCA) may be applied for feature selection of the first set of data or the mood data.

According to one aspect, the fuzzy logic inference system 124 may receive the second set of data and perform classification on the second set of data to determine or identify one or more driving styles for an associated individual. The fuzzy logic inference system 124 may perform classification on the second set of data by evaluating an individual's reaction to the defined event presented during the simulation phase or the data collection phase to establish how these aspects such as aggression, sedate, keenness, excitement, anxiety, etc. may be translated into numerical values. The fuzzy logic inference system 124 may perform classification on the second set of data based on a Non-dominated Sorting Genetic Algorithm II (NSGA-II) which optimizes weights for the classification.

According to one aspect, the hierarchical cluster analyzer 126 may receive the third set of data and perform clustering on the third set of data to determine one or more personality types for an associated individual.

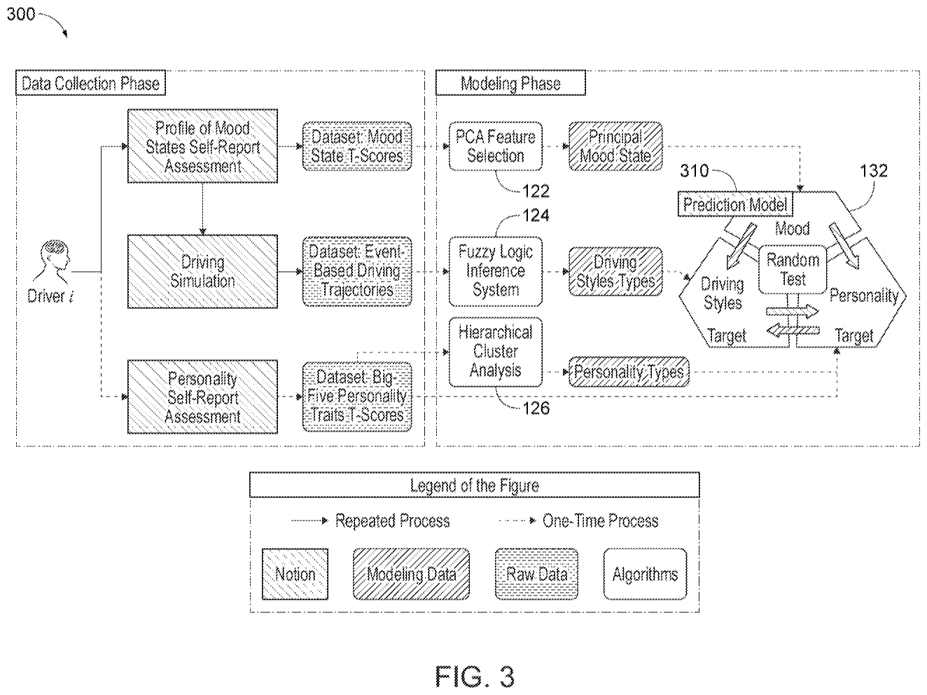

Generally, modeling behavioral characteristics of an individual may be complex as the behavioral characteristics may be associated with a variety of temporal factors (e.g., traffic condition, surrounding vehicles, weather, time of the day, etc.). According to one aspect, the model generator 132 may generate a prediction model 310 of FIG. 3 based on the first set of data, the second set of data, the third set of data, and/or any of the aforementioned temporal factors. The model generator 132 may generate the prediction model 310 based on random decision forest. In this way, the relationship between driving styles, mood states, and the prediction model 310 created using random forest may be developed for driving styles and personality types.

According to one aspect, the prediction model 310 may generate a prediction for profile modeling by receiving a first input of the same data type as the first set of data, a second input of the same data type as the second set of data and output the prediction for profile modeling having the same data type as the third set of data based on the first input and the second input. For example, the prediction model 310 may generate the prediction for profile modeling by receiving mood information from the mobile device 180 and driving style information from the vehicle 150 to predict the personality of an individual.

According to another aspect, the prediction model 310 may generate a different or second prediction for profile modeling by receiving a first input of the same data type as the first set of data, a second input of the same data type as the third set of data and outputting the prediction for profile modeling having the same data type as the second set of data based on the first input and the second input. For example, the prediction model 310 may generate the prediction for profile modeling by receiving mood information from the mobile device 180 and personality information of an individual to predict the driving style of the individual. In this way, the model generator 132 may generate two or more different types of prediction models 310.

Any of the sensors of the system for model generation, the mobile device 180, or the vehicle 150 may be used to detect or estimate the first input or the second input (e.g., the mood state information associated with the individual). For example, the microphone or image capture device of the mobile device 180 may capture mood state information based on tonal inflection of the voice of the individual via an application run or executed via the API 192. If the mobile device 180 is a fitness tracker or smartwatch, sensors of the mobile device 180 may capture a heart rate or other biometric data which may be used to estimate the mood state information of the individual. Similarly, the image capture device of the vehicle 150 or microphone of the vehicle 150 may receive the mood state information of the individual via a monitoring camera.

Sensors from the vehicle 150 or the mobile device 180 may be used to estimate or determine the driving style information associated with the individual (e.g., the first input or the second input for the prediction model 310). For example, the mobile device 180 may have an accelerometer which may measure how quickly the individual accelerates while driving. Similarly, the vehicle 150 may be equipped with one or more vehicle systems 162 which may measure or detect driving maneuvers and associated driving style information. Other examples of information obtained as the first input or the second input may include vehicle operation states (e.g., speed, acceleration, angular speed, etc.).

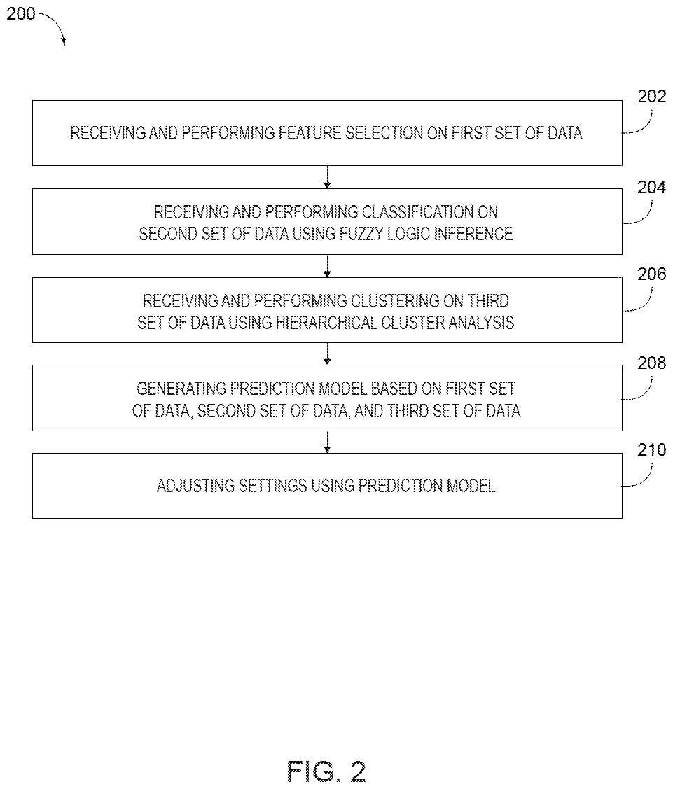

FIG. 2 is an exemplary flow diagram of a computer-implemented method for profile modeling, according to one aspect. The computer-implemented method for profile modeling may include receiving 202 a first set of data and performing feature selection on the first set of data, receiving 204 a second set of data and performing classification on the second set of data using fuzzy logic inference, receiving 206 a third set of data and performing clustering on the third set of data using hierarchical cluster analysis, generating 208 a prediction model 310 based on the first set of data, the second set of data, and the third set of data, and adjusting 210 one or more settings based on or using the prediction model 310. In this way, findings from the prediction model 310 may be utilized to determine or estimate risky driving styles.

The prediction model 310 may generate a prediction for profile modeling by receiving a first input of the same data type as the first set of data, a second input of the same data type as the second set of data and outputting the prediction for profile modeling having the same data type as the third set of data. The prediction model 310 may generate a prediction for profile modeling by receiving a first input of the same data type as the first set of data, a second input of the same data type as the third set of data and outputting the prediction for profile modeling having the same data type as the second set of data. In this way, the prediction model 310 may predict or estimate a driving style using, given, or based on inputs of mood states and personality traits or predict or estimate an inference model for personality types (e.g., obtained by clustering) using, given, or based on inputs of mood states and driving styles.

Examples of settings which may be adjusted based on the prediction model 310 include one or more vehicle system settings, such as ADAS settings, autonomous operation settings, HUD settings (e.g., displaying predicted behaviors of other vehicles or objects), etc. For example, if the prediction model 310 generates the prediction for profile modeling by receiving a first input of mood information, a second input of personality information, and outputting the prediction for profile modeling of a predicted driving style, the system 100 for profile modeling may adjust, enable, or disable ADAS settings, ADAS strategies, or autonomous operation settings to account for or in accordance with the predicted driving style. Continuing with this example, if the predicted driving style is aggressive, for example, the ADAS settings or autonomous operation settings may be adjusted to that one or more associated tolerances reflect the predicted aggressive driving style (e.g., closer following distance than other driving styles, higher maximum speeds or greater acceleration, etc.).

Other examples of settings which may be adjusted based on the prediction model 310 may include mobility as a service (MaaS) settings or physical human robot interaction (pH RI) settings. For example, when a user requests a ride from a MaaS, the user may interface with a MaaS application, which may be installed and executed from the mobile device 180 of the user via the API 192. This MaaS application may select a driver and/or other passengers for the requested ride by matching personality types or driving styles between the user and the driver, for example. As another example, settings may be adjusted to promote user acceptance of automated features of the vehicle 150. In this way, finding from the prediction model 310 may be utilized to determine or estimate preferences for MaaS.

FIG. 3 is an exemplary architecture or framework 300 for the system 100 for profile modeling of FIG. 1, according to one aspect. The framework 300 of FIG. 3 enables evaluation of driving styles and corresponding mood states. As seen in FIG. 3, a data collection phase and a modeling phase may be provided and the driving simulator of FIG. 3 may provide a controlled environment to ensure that participants experience the same scenarios and pre-defined or defined events.

As previously discussed, during the data collection phase, each participant may follow procedures as their mood states, driving trajectory, and personality traits may be collected. As one part of driver profile modeling, the correlation between mood states and personality traits may be investigated using their respective scores. A longitudinal user study was designed and data collection was conducted to integrate the driving style, personality traits, and mood state of each participant into a single dataset. Algorithms for profiling the mood states, personality traits, and driving styles of participants are described herein.

During the modeling phase, training and test datasets may be split. According to one experiment, for the assessment of mood states, three principal components from mood states explained 93% of mood states, and based on the contribution to three principal components, five out of eight significant features (e.g., Tension, Vigor, Fatigue, Friendliness, and total mood disturbance (TMD)) were selected. Four driving styles were determined by the fuzzy logic inference system 124 based on driving trajectories and three personality types were clustered by HCA. Thereafter, the prediction model 310 may be trained and validated by random forest, enabling the prediction of driving style with mood states and personality traits and personality types with mood states and driving style.

### Fuzzy Logic Inference System 124

To utilize prior knowledge of driving trajectory, the fuzzy logic inference system 124 may be adopted to classify driving styles by interpreting the fuzzy linguistic terms given by one or more definitions, such as the definitions of Table I provided herein. Explained yet another way, the fuzzy logic inference system 124 may receive the dataset event based driving trajectories from the driving simulation and perform fuzzification on the dataset event based driving trajectories to produce a fuzzy input set a set of fuzzy rules, which may be predefined from Table I, for example, may be received and utilized to generate a fuzzy output set. In other words, the fuzzy logic inference system 124 may generate the fuzzy output set based on the fuzzy rules and the fuzzy input set. Thereafter, the fuzzy logic inference system 124 may perform defuzzification on the fuzzy outset set to generate an output for the fuzzy logic inference system 124. The output for the fuzzy logic inference system 124 may represent classification on the received set of data from the driving simulation as a probability. For example, with reference to Table I, the output of the fuzzy logic inference system 124 may be a probability level that a driver is associated with the aggressive driving style, the anxious driving style, the keen driving style, and/or the sedate driving style. To ensure separation between driving styles, one or more weights used by the fuzzy logic inference system 124 may be optimized, as described herein.

Given the driving trajectories collected in the simulator from the simulation phase, the fuzzy logic inference system 124 may estimate the probability of how each trajectory may be classified into a predefined driving style. The classification may be performed based on a highest probability. For example, the fuzzy logic inference system 124 may evaluate drivers' reactions to one or more of the defined events and final probability may be calculated by a weighted sum of each reaction. For example, an average speed of 110 mph in a session may be labeled as Very High, and the probability that the corresponding driving style is typified as aggressive may increase, and at the same that that the probability of the driving style being classified as anxious may decrease.

Considering the difference in driving trajectories between city and highway scenarios, two corresponding sets of fuzzy rules may be developed by the fuzzy logic inference system 124 for each scenario type to analyze the reactions to the defined events, including normal driving (e.g., cruising without surrounding vehicle), vehicle following, stop sign approaching and departure, and lane change scenarios. In the city scenario, intersections and normal driving may account for the majority of the scene. According to one aspect, to evaluate how the participants performed on city roads, four features were selected, including average speed near speed limit signs, minimum speed at stop signs, maximum acceleration after stop, and maximum deceleration when approaching stop signs. In the highway scenario, driving style may be analyzed by the subject or individual's interaction with surrounding vehicles and normal driving. In this way, four features selected from different events were evaluated, including average speed near speed limit signs, maximum brake force when another vehicle cuts in, minimum time headway to the preceding vehicle, and lane change rate (e.g., lane change occurrence per mile). Based on predefined fuzzy rules, the fuzzy logic inference system 124 may quantify linguistic probability (e.g., from not likely to very likely) into probability values. An exemplary set of fuzzy rules are shown in TABLE I below:

TABLE I

| | | Aggressive | Anxious | Keen | Sedate |
|---|---|---|---|---|---|
| Speed | Low | NL | VL | HL | L |
| | Medium | HL | HL | VL | VL |
| | High | L | NL | L | NL |
| | Very High | VL | NL | NL | NL |
| Brake | Light | VLK | HL | HL | L |
| | Medium | L | NL | VL | HL |
| | High | HL | VL | L | NL |

### NL—Not Likely, HL—Hardly Likely, L—Likely, VL—Very Likely

The probability of each driving style may be expressed as Equation (1), where a weight factor w_{ds,f} may be introduced to define how much a feature (f) contributes to a particular driving style:

p(ds)=Σ_{f∈features}w_{ds,f}·p(ds|f) (1)

where ds∈DS={Aggressive, Anxious, Keen, Sedate}, and Σw_{ds,f}=1.

To mitigate ambiguities in classification between similar driving styles (e.g., aggressive with keen, anxious with sedate), the Non-Dominated Sorting Genetic Algorithm II (NSGA-II) may be adopted to optimize the weights w_{ds,f}. As presented in Equation (2), two objective functions may be maximized by tuning the weights. F₁ may be the sum of the probability difference between each pair of driving styles, and F₂ may be used to find the probability of the most probable driving style. This optimization process may improve classification certainty by maximizing both F₁ and F₂.

$$\begin{matrix}{F}_{1} = {\sum }_{i = 1}^{3} {\sum }_{j = i + 1}^{4} {‖ P ( D {S}_{i} ) - P ( D {S}_{j} ) ‖}_{2} \\ {F}_{2} = \begin{matrix}arg min \\ ds ∈ Ds\end{matrix} ( {\sum }_{k = 1}^{N} p k ( ds ) / N ) ) \\ F ( w ) = maximize ( {F}_{1} ( w ) , {F}_{2} ( w ) ) \\ s . t . 0 \leq {w}_{d s , f} \leq 1\end{matrix} \qquad ( 2 )$$

where P(DSᵢ) may be the combination of probabilities of i-th driving style in each session for the participants, p(DSᵢ)={p₁(DSᵢ), . . . , pᵢ(DSᵢ)}, N may be the number of sessions to be evaluated, and pₖ(ds) may be the probability of ds at k-th session.

According to one aspect, the fuzzy logic inference system 124 may receive the input dataset, perform fuzzification on the input dataset, receive fuzzy rules, such as the rules of Table I, perform inference based on the fuzzy input dataset and the fuzzy rules to generate a fuzzy output dataset, and perform defuzzification on the fuzzy output dataset to generate the output to be input to the model generator 132.

### Prediction Model 310 Based on Random Forest

The prediction may be formulated as a classification problem with the characteristics of the dataset taken into consideration and Random Forest may be used as the classifier as Random Forest may process inputs with categorical variables where input data may be a synthesis of categorical variables (e.g., types) and continuous variables (e.g., score values). Further, random forest may reduce over-fitting in a small-sample dataset with Bootstrap Aggregating (Bagging). Also, because a dataset may be unbalanced with an unequal distribution of mood states and driving styles, the random forest may account for unbalanced datasets effectively by weighting each class. Additionally, the results from classification may be voted by multiple decision trees, thereby improving their robustness.

As shown in the prediction model 310 of FIG. 3, when the prediction target is the driving style, the inputs may be personality traits, personality types (e.g., obtained from the HCA), and mood states. As another possibility, when predicting personality types, the inputs may be driving styles and mood states. To improve prediction accuracy, grid search (e.g., exhaustive search) with 5-fold cross-validation may be used to tune the hyper-parameter of the random forest model. For example, parameters may be tuned, including a number of decision trees (nₜᵣₑₑ), a maximum depth of the tree (dₘₐₓ), and a number of features to randomly investigate (n_{f}). As an exemplary result, for driving styles prediction, nₜᵣₑₑ may be 100, dₘₐₓ may be 50, and n_{f} may be 3. Additionally, for personality types prediction, nₜᵣₑₑ may be 42, dₘₐₓ may be 70, and n_{f} may be 3.

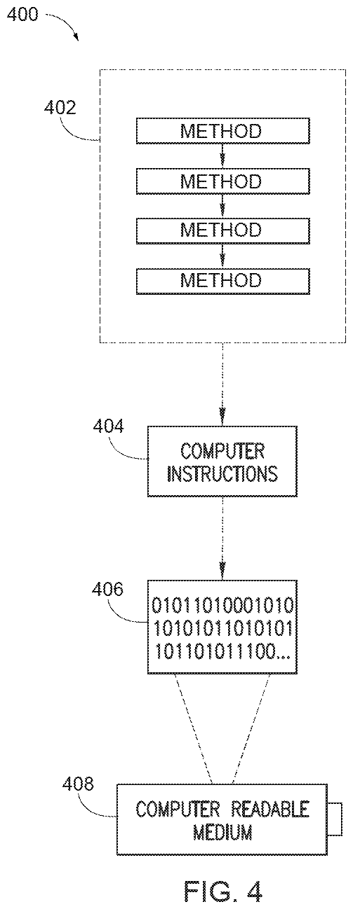

Still another aspect involves a computer-readable medium including processor-executable instructions configured to implement one aspect of the techniques presented herein. An aspect of a computer-readable medium or a computer-readable device devised in these ways is illustrated in FIG. 4, wherein an implementation 400 includes a computer-readable medium 408, such as a CD-R, DVD-R, flash drive, a platter of a hard disk drive, etc., on which is encoded computer-readable data 406. This encoded computer-readable data 406, such as binary data including a plurality of zero's and one's as shown in 406, in turn includes a set of processor-executable computer instructions 404 configured to operate according to one or more of the principles set forth herein. In this implementation 400, the processor-executable computer instructions 404 may be configured to perform a method 402, such as the method 200 of FIG. 2. In another aspect, the processor-executable computer instructions 404 may be configured to implement a system, such as the system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

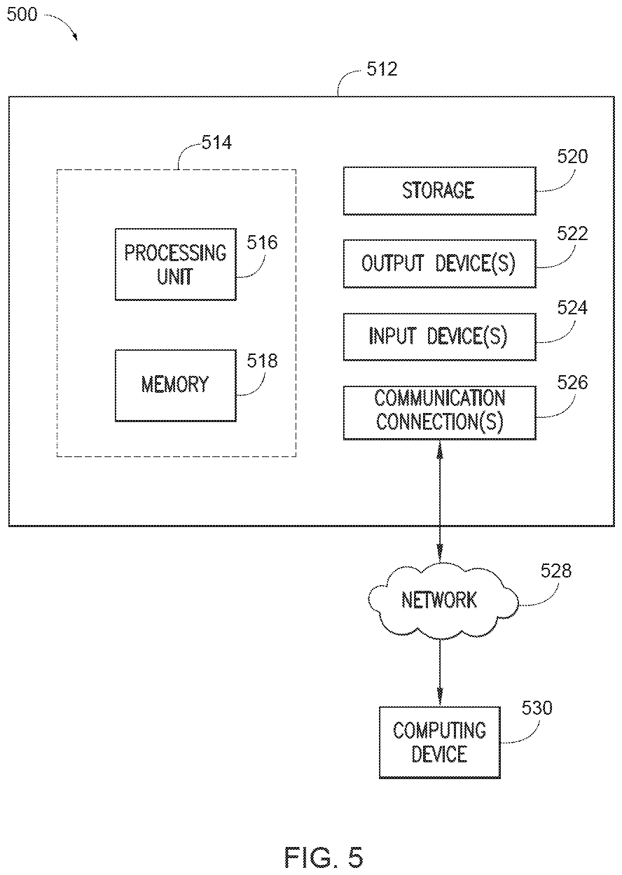

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A system for profile modeling, comprising:
a feature selector, receiving a first set of data and performing feature selection on the first set of data;
a fuzzy logic inference system, receiving a second set of data and performing classification on the second set of data;
a hierarchical cluster analyzer, receiving a third set of data and performing clustering on the third set of data; and
a model generator, generating a prediction model based on the first set of data, the second set of data, and the third set of data,
wherein the prediction model generates a prediction for profile modeling by receiving a first input of the same data type as the first set of data, a second input of the same data type as the second set of data and outputting the prediction for profile modeling having the same data type as the third set of data.

2. The system for profile modeling of claim 1, wherein the data type of the first set of data is mood state information associated with an individual, including anger, confusion, depression, fatigue, tension, or vigor.

3. The system for profile modeling of claim 1, wherein the data type of the second set of data is driving style information associated with an individual, including aggressive, anxious, keen, or sedate.

4. The system for profile modeling of claim 1, wherein the data type of the third set of data is personality trait information associated with an individual, including neuroticism, extroversion, openness, agreeableness, or conscientiousness.

5. The system for profile modeling of claim 1, wherein the fuzzy logic inference system performs classification on the second set of data by evaluating an individual's reaction to a defined event presented during simulation or a data collection phase.

6. The system for profile modeling of claim 5, wherein the defined event is one of a normal driving scenario without surrounding vehicles, a vehicle following scenario, a stop sign scenario, or a lane change scenario within the simulation or the data collection phase.

7. The system for profile modeling of claim 5, wherein evaluating the individual's reaction to the defined event includes monitoring a speed near a speed limit sign, a minimum speed at a stop sign, a maximum acceleration after the stop sign, or a maximum deceleration near the stop sign within the simulation or the data collection phase.

8. The system for profile modeling of claim 1, wherein the fuzzy logic inference system performs classification on the second set of data based on a Non-dominated Sorting Genetic Algorithm II (NSGA-II) which optimizes weights for the classification.

9. The system for profile modeling of claim 1, wherein the model generator generates the prediction model based on random decision forest.

10. The system for profile modeling of claim 1, wherein the prediction model generates a second prediction for profile modeling by receiving the first input of the same data type as the first set of data, the second input of the same data type as the third set of data and outputting the prediction for profile modeling having the same data type as the second set of data.

11. A computer-implemented method for profile modeling, comprising:
receiving a first set of data and performing feature selection on the first set of data;
receiving a second set of data and performing classification on the second set of data using fuzzy logic inference;
receiving a third set of data and performing clustering on the third set of data using hierarchical cluster analysis; and
generating a prediction model based on the first set of data, the second set of data, and the third set of data,
wherein the prediction model generates a prediction for profile modeling by receiving a first input of the same data type as the first set of data, a second input of the same data type as the second set of data and outputting the prediction for profile modeling having the same data type as the third set of data.

12. The computer-implemented method for profile modeling of claim 11, wherein the data type of the first set of data is mood state information associated with an individual, including anger, confusion, depression, fatigue, tension, or vigor.

13. The computer-implemented method for profile modeling of claim 11, wherein the data type of the second set of data is driving style information associated with an individual, including aggressive, anxious, keen, or sedate.

14. The computer-implemented method for profile modeling of claim 11, wherein the data type of the third set of data is personality trait information associated with an individual, including neuroticism, extroversion, openness, agreeableness, or conscientiousness.

15. A system for profile modeling, comprising:
a feature selector, receiving a first set of data and performing feature selection on the first set of data;
a fuzzy logic inference system, receiving a second set of data and performing classification on the second set of data;
a hierarchical cluster analyzer, receiving a third set of data and performing clustering on the third set of data; and
a model generator, generating a prediction model based on the first set of data, the second set of data, and the third set of data,
wherein the prediction model generates a prediction for profile modeling by receiving a first input of the same data type as the first set of data, a second input of the same data type as the third set of data and outputting the prediction for profile modeling having the same data type as the second set of data.

16. The system for profile modeling of claim 15, wherein the data type of the first set of data is mood state information associated with an individual, including anger, confusion, depression, fatigue, tension, or vigor.

17. The system for profile modeling of claim 15, wherein the data type of the second set of data is driving style information associated with an individual, including aggressive, anxious, keen, or sedate.

18. The system for profile modeling of claim 15, wherein the data type of the third set of data is personality trait information associated with an individual, including neuroticism, extroversion, openness, agreeableness, or conscientiousness.

19. The system for profile modeling of claim 15, wherein the fuzzy logic inference system performs classification on the second set of data by evaluating an individual's reaction to a defined event presented during simulation or a data collection phase.

20. The system for profile modeling of claim 19, wherein the defined event is one of a normal driving scenario without surrounding vehicles, a vehicle following scenario, a stop sign scenario, or a lane change scenario within the simulation or the data collection phase.
